(19) United States
(12) Patent Application Publication
(10) Pub. No.: US 2002/0164426 A1
(43) Pub. Date: Nov. 7, 2002

(54) Method of adhering coatings to substrates

(76) Inventors: Thomas James Ennis, Glenmoore, PA (US); William Harrison Hill, Bensalem, PA (US); William August Kirn, King of Prussia, PA (US); Joseph Martin Rokowski, Riegelsville, PA (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/095,605

(22) Filed: Mar. 11, 2002

Related U.S. Application Data
(63) Continuation-in-part of application No. 09/659,855, filed on Sep. 11, 2000.
(60) Provisional application No. 60/155,719, filed on Sep. 23, 1999.
(60) Provisional application No. 60/277,744, filed on Mar. 22, 2001.

(51) Int. Cl. B05D 3/10

(52) U.S. Cl. 427/322

(57) ABSTRACT

Adhesion between a coating and a substrate may be improved by pre-treating the surface of the substrate with an aqueous detergent composition having a pH above 8 and comprising from 1 to 10% by weight phosphate and from 1 to 10% by weight silicate, before application of the coating.

This invention is concerned with improving the adhesion of coatings to substrates. More particularly, though not exclusively, this invention is concerned with a method for improving the adhesion of a coating to aluminum, galvinized steel, vinyl, PVC, TPO, Hypalon®, pressure treated wood, plywood and bitumenous substrates, as well as chalky acrylic coated surfaces of such substrates.

EPDM and asphalt membranes encompass about 70% of the total roofing market. A large portion of the remaining market consists of various metal substrates, such as aluminum and galvanized steel. Other substrates used comprise single ply substrates made from PVC (polyvinyl chloride), TPO (thermoplastic polyolefin) and Hypalon®. Hypalon is a trade name for a sysnthetic rubber produced by DuPont Dow. It is described as a chlorosulfonated polyethylene and is produced as white chips. It can be used for the production of many products, including sheet roofing substrates and protective/decorative coatings. Still other substrates used comprise spray applied polyurethane foam. All of these substrates can benefit from the use of a coating to improve aesthetics, reduce energy costs, and improve durability.

The architectural coatings industry use paints to coat similar substrates used in the roofing market. The paint market has somewhat different performance criteria than coatings used in roofing; i.e. paints are applied thinner (3 to 8 dry mls versus 20 to 25 dry mls for roof mastics) and paints are not expected to perform in areas where water ponding is prevalent. Many of the metals used in the roofing market are used for applications in the architectural markets. Metal used in both the architectural and roofing markets can be factory applied as well as painted at the job site. The architectural coatings industry utilize many other substrates, not prevalent in the roofing market. Pressure treated wood, chalky acrylic and factory applied coatings to aluminum and vinyl substrates are examples of commonly used materials that can be painted. Coating these substrates is necessary because of degradation and weathering. Weathered substrates that have been previously painted frequently have chalky surfaces that are difficult to adhere to, yet need to be re-coated to prevent degradation of the substrate.

In either the roofing or architectural industry the key criteria for the coating is the ability of this coating to adhere well to the substrate. Cleaning with water before coating may improve adhesion of the coating as compared to not rinsing the substrate surface and cleaning with detergents has also shown to help. The detergent of the present invention exhibits an ability to significantly improve adhesion properties of substrates to coatings. Several substrates have shown to be difficult to adhere to, such as aluminum, galvanized steel, pressure treated wood and weather treated pine. The use of the aqueous detergent composition and method of the present invention has improved adhesion to such substrates.

A coating system which displays good adhesion and superior resistance to blistering, especially when exposed to ponded water is disclosed in U.S. Pat. No. 5,059,456. This system relies upon the use of a water-based tiecoat between the membrane and the coating. The tiecoat consists of a water-insoluble latex polymer and multivalent metal ion, wherein the latex polymer comprises units such as would result from preparation from a monomer mixture comprising at least 20 weight %, based on the weight of the monomer mixture, of at least one hydrophobic monomer selected from the group consisting of (C₄-C₂₀)-alkyl methacrylates and (C₈-C₂₀)-alkyl acrylates, and from 3.0 weight % to 7.5 weight % of methacrylic acid, based on the weight of the monomer mixture, and where the latex polymer has a glass transition temperature of from −20° C. to 5° C., and where the molar ratio of the multivalent metal ion to the methacrylic acid in the latex polymer is from about 1:1 to about 0.375:1. The tiecoat is applied to a membrane before subsequent application of a coating. Though this system offers properties of adhesion and resistance to blistering which are superior to conventional mastic systems on bituminous membranes, there is no disclosure of coating aluminum, galvinized steel or pressure treated wood substrates.

It is an object of the present invention to provide a coating system that offers improved adhesion on aluminum, galvinized steel, vinyl, PVC, TPO, Hypalon®, pressure treated wood, plywood and bitumenous substrates, as well as chalky acrylic coated surfaces of such substrates.

Surprisingly, it has been found that by pre-treating a substrate with said detergent composition before applying a conventional coating composition, a synergistic improvement in adhesion between the substrate and coating can be achieved. The surprising advantages of the present invention may be measured for both coatings applied on newly laid substrates and coatings applied on old substrates that have been previously coated and left for an extended period of time.

Preferably, the substrate for application of the invention is aluminum, galvinized steel, vinyl, PVC, Hypalon®, pressure treated wood or plywood. Preferably, the aqueous detergent composition of the present invention is allowed to sit for five (5) minutes, followed by the rinsing step. Preferably the rinsing step includes both a power wash at a pressure of 193×10⁵ N/m² (2500 psi) and a non-presured rinse.

The coating composition may be any composition traditionally used in coating such sunbstrates, preferably comprising a water-insoluble latex polymer binder, having a glass transition temperature of from −45° C. to 50° C. (as measured by the Fox equation), which is preferably acrylic or styrene/acrylic. In addition to the latex polymer, the composition will comprise at least one or more of the following components: pigments, extenders, dispersants, surfactants, coalescents, wetting agents, thickeners, rheology modifiers, drying retarders, plasticizers, biocides, mildewicides, defoamers, colorants, waxes, dirt pick-up retarders, adhesion promoters, zinc oxide and solid silica. The coating composition is preferably an architectural roof coating composition or mastic coating composition. The binder used in the coating composition is preferably a commercially available binder useful for such applications, such as a binder selected from the group including Rhoplex AC-261, Rhoplex EC-1791, Rhoplex 2019R and Rhoplex EC-2885 available from Rohm and Haas Company; Acronal NX 3250 available from BASF AG and DA26NA available from Dow. More preferably, the binder is selected from the group including Rhoplex AC-261, Rhoplex EC-1791, Rhoplex EC-2885 and Acronal NX 3250. Rhoplex AC-261 and Rhoplex EC-1791 are the most preferred coating compositions.

The aqueous detergent composition comprises from 1 to 10%, preferably 2 to 8%, more preferably 3 to 6%, by weight of said composition of a mono- or poly-phosphate or a mixture of such phosphates, preferably selected from the group consisting of trisodium phosphate, sodium tripolyphosphate and tripotassium phosphate. Trisodium phosphate is the most preferred. The aqueous detergent composition comprises from 1 to 10%, preferably 2 to 8%, more preferably 3 to 6%, by weight of said composition of a meta-, ortho- or para-silicate or a mixture of such silicates, preferably selected from the group consisting of sodium metasilicate and potassium metasilicate. Sodium metasilicate is the most preferred. The phosphates and silicates useful in the detergent composition are those commonly used in conventional detergent compositions, such as in dish-washing and clothes-washing detergents.

The aqueous detergent composition may also comprise other components typically found in aqueous detergent composition. For example, the composition may comprise up to 5%, preferably up to 2%, by weight of at least one compound selected from the group consisting of octylphenoxy polyethoxy ethanol, octyphenoxy polyethoxy ethylphosphate, polyethylene glycol and phosphoric acid.

The aqueous detergent composition has a pH of above 8, preferably a pH from 9 to 14, and most preferably a pH from 12 to 14.

The best results are obtained from the present invention when all the surface of the substrate is contacted with the detergent composition. The detergent composition may be spread over the surface by spray application methods or with the aid of a stiff brush. The detergent composition should preferably be left to stand in contact with the surface of the membrane for a minimum of five (5) minutes. For example, though an improvement in adhesion of a coating may be measured when the detergent composition is left to treat the surface for less than 30 seconds, the best results are achieved when the detergent composition is allowed to contact the surface for at least 5 minutes. A contact time significantly over 5 minutes will tend not to lead to any significant further improvements in adhesion, though in practice contact times may be 10 to minutes depending on the size of the substrate and the speed of the operator. Permitting the detergent to dry on the surface before rinsing may not be detrimental to the method of the present invention, provided the surface is rinsed well afterwards to remove the detergent.

The best results are obtained from the present invention when rinsing the substrate's surface removes substantially all of the detergent composition. High efficiency rinsing may involve the use of a stiff brush and/or the use of a high pressure hose. Typically, the high pressure hose will release rinse water at 193 ×10⁵ N/m² (2500 psi).

The following Examples, including Comparative Examples, are given solely for the purpose of illustrating the invention and are in no way to be considered limiting.

### Tests

In the examples, the coatings are subjected to dry and wet adhesion tests. These are performed in accordance with ASTM Protocol D903.

### EXAMPLE 1

Preparation of Aqueous Detergent Composition

An aqueous detergent composition, with the formulation indicated in Table 1, was prepared by mixing the components in the prescribed amounts in a pail. The composition was mixed in the pail until all components appeared to have dissolved. The aqueous detergent composition was prepared in in accordance with the present invention and has a pH above 13.

TABLE 1
Aqueous Detergent Composition

| Detergent Components | Parts by Weight |
|---|---|
| Sodium Metasilicate | 5 |
| Soap | 2.4 |
| Trisodium phosphate | 5 |
| Water | 87.8 |

Soap = 127 parts octylphenoxypolyethoxyethanol
58.5 parts octylphenoxypolyethoxyethylphosphate
3.9 parts polyethylene glycol
11.7 parts phosphoric acid
18.9 parts water

### EXAMPLE 2

Substrate preparation

Various substrates, as shown in Example 3, were laid flat on a surface. The upper surface of each substrate was then washed with tap water using a high pressure hose. After washing with water, 30 cm² sections of each substrate was then treated with the detergent composition of Example 1, by spray application of about 100 cm³ of detergent composition over the surface to be treated and brushing the composition over the surface and allowing it to stand for 5 minutes. Then the detergent composition was washed away with tap water from a high pressure hose at 193×10⁵ N/m² (2500 psi).

Each of the treated sections and a section not treated with detergent on each substrate was then coated in a conventional manner with a general composition as shown below in Tables 2.1 through 2.4.

TABLE 2.1
Coating Formulation EC-1791

| | | kg/378.54 liters |
|---|---|---|
| | INGREDIENTS | (lbs/100 gal) |
| GRIND: | | |
| A. | Water | 69.2 (152.5) |
| | Tamol ® 850 | 2.2 (4.8) |
| | KTPP | 0.6 (1.4) |
| | Nopco NXZ | 0.9 (1.9) |
| B. | Duramite | 191.5 (422.2) |
| | Ti-Pure R-960 | 31.9 (70.4) |
| | Kadox 915 | 21.3 (46.9) |
| LETDOWN: | | |
| C. | Rhoplex ® EC-1791 (55%) | 213.5 (470.6) |
| | Nopco NXZ | 0.9 (1.9) |
| D. | Texanol | 3.2 (7.0) |
| | Skane ® M-8 | 1.0 (2.1) |
| E. | NH₄OH (28%) | 0.5 (1.0) |
| F. | Propylene Glycol | 11.1 (24.4) |
| | Natrosol 250 MXR | 1.9 (4.2) |
| PHYSICAL CONSTANTS: | | |
| Solids Content, % | | |
| by Weight | | 66.9 |
| by Volume | | 50.8 |
| PVC | | 43.0 |
| Density, kg/l | | 1.45 |
| | | (12.1 lbs/gal) |
| Viscosity, KU | | 95.0 |
| PH | | 8.6 |

Tamol 850 is a surfactant available from Rohm and Haas Company
KTPP is potassium tripolyphosphate
Nopco NXZ is available from Henkel Corp
Duramite is available from ECC America, Inc
Ti-Pure R-960 is titanium dioxide available from E I DuPont de Nemours., Inc
Kadox is available from Zinc Corp. of America
Texanol is available from Eastman Kodak
Skane M-8 is a mildewcide available from Rohm and Haas Company
Natrosol 250 MXR is available from Aqualon, Inc.

TABLE 2.2
Coating Formulation MB-3640

| | | kg/378.54 liters |
|---|---|---|
| | INGREDIENTS | (lbs/100 gal) |
| A. Grind | Water | 65.8 (145.0) |
| | Tamol 165A | 2.59 (5.7) |
| | Aqueous Ammonia (28%) | 1.36 (3.0) |
| | Nopco NXZ | 1.36 (3.0) |
| | Duramite | 178.04 (392.5) |
| | TiPure R-960 | 28.35 (62.5) |
| B. Letdown Phase under | Nopco NXZ | 1.36 (3.0) |
| mild agitation | Lipacryl ®MB-3640 | 222.3 (490.1) |
| C. Premix B: | Water | 5.76 (12.7) |
| Premix the following | Texanol | 2.72 (6.0) |
| ingredients and add | Skane M-8 | 1.36 (3.0) |
| slowly while stirring. | | |
| D. Premix C: | | |
| Premix the following | | |
| ingredients and add | | |
| slowly while string. Mix | | |
| for a minimum of 15 | | |
| minutes or until | | |
| consistency is smooth. | | |
| Propylene Glycol | | 4.53 (10.0) |
| Natrosol ®250HR | | 1.81 (4.0) |
| E. Adjust pH to 9.0-10.0 | | |
| with | | |
| Aqueous Ammonia (28%) | | |
| Physical Constants: | | |
| Solids Content, % | | |
| By weight | 64.3 | |
| By Volume | 50.1 | |
| PVC | 38.8 | |
| Density, lbs/gal | 11.4 | |
| PH | 9.0-10.0 | |

TABLE 2.3
Coating Formulation AC-261 or ML 200 Sheen

| | | kg/378.54 liters |
|---|---|---|
| | INGREDIENTS | (lbs/100 gal) |
| Grind | | |
| A | Tamol 731 (25%) | 7.24 (15.97) |
| | Propylene Glycol | 34.8 (76.72) |
| | Foamaster VL | 0.48 (1.06) |
| | Rozone 2000 | 1.18 (2.60) |
| | Acrysol RM-825 | 0.53 (1.19) |
| | Water | 45.36 (100.00) |
| | Ti-Pure R-902 | 120.72 (266.15) |
| | Minex 4 | 48.29 (106.47) |
| Letdown | | |
| B | Rhoplex AC-261 or | 205.2 (452.47) |
| | Rhoplex ML-200 | |
| C | Texanol | 10.14 (22.36) |
| D | Foamaster VL | 0.48 (1.06) |
| E | Acrysol RM-2020 | 12.07 (26.60) |
| F | Water | 26.92 (59.34) |
| Physical Constants: | | |
| Solids Content, % | | |
| By weight | 53.99 | |
| By Volume | 37.36 | |
| PVC | 35.00 | |
| Density, lbs/gal | 11.3 | |
| pH | 9.0-10.0 | |

TABLE 2.4
Coating Formulation for Test Sample

| | | kg/378.54 |
|---|---|---|
| | | liters |
| | INGREDIENTS | (lbs/100 gal) |
| Grind | | |
| A | Natrasol 250 | 45.36 (100) |
| | MHR (2.5%) | |
| | Ethylene Glycol | 9.43 (20.8) |
| | Propylene Glycol | 13.2 (29.2) |
| | Tamol 1124 | 1.7 (3.8) |
| | Colloids 643 | 0.8 (1.7) |
| | Rozone | 2.6 (5.7) |
| | Ti-Pure R-902 | 52.6 (120.7) |
| | Icecap K | 5.2 (12.1) |
| | Celite 281 | 15.6 (36.2) |
| Letdown | | |
| B | OP-96 | 41.5 (96.67) |
| C | Rhoplex ML-200 | 131.0 (288.7) |
| D | Texanol | 4.1 (9.3) |
| E | Colloids 643 | 0.7 (1.7) |
| F | Aq | 0.2 (0.5) |
| | Ammonia (28%) | |
| G | RM-2020 | 5.2 (12.0) |
| H | Water | 55.2 (121.7) |
| Physical Constants: | | |
| Solids Content, % | | |
| By weight | | |
| By Volume | 30.0 | |
| PVC | 45.00 | |
| Density, lbs/gal | 11.3 | |

### EXAMPLE 3

Testing Different Coating Compositions on Various Substrates

The dry and wet adhesion properties and blister properties of different commercially available coating compositions were evaluated on various substrates, as described above, with the aqueous detergent composition of Example 1. The results are shown in Tables 3, 4, 5 and 6.

TABLE 3
180 Degree Peel Adhesion
For Dry Film Coating Applications of 8-10 mils
Measured in Newtons/Meter

| | | | 7 Day Testing Time | |
|---|---|---|---|---|
| | 7 Day Testing Time | | Dry/4 Hour | |
| | Dry Condition | | Wet Condition | |
| | Without | With | Without | With |
| Substrate | Detergent | Detergent | Detergent | Detergent |
| coating binder | Treatment | Treatment | Treatment | Treatment |
| Galvanized Steel | | | | |
| Rhoplex AC-261 | 350 | 788 | 350 | 455 |
| Rhoplex EC-1791 | 438 | 438 | 245 | 333 |
| Aluminum Panel | | | | |
| Rhoplex AC-261 | 140 | 1015 | 228 | 455 |
| Rhoplex EC-1791 | 262 | 490 | | |
| Aluminum Siding | | | | |
| with chalky acrylic | | | | |
| coated surface | | | | |
| Rhoplex ML-200 | 000 | 350 | | |
| Rhoplex EC-1791 | 403 | 490 | | |
| Vinyl Siding | | | | |
| Rhoplex ML-200 | 438 | 525 | 53 | 175 |
| Rhoplex EC-1791 | 490 | 508 | 210 | 525 |
| Pressure Treated | | | | |
| White Pine | | | | |
| Rhoplex AC-261 | 875 | 963 | 525 | 613 |
| Plywood; T-11 | | | | |
| Rhoplex ML-200 | 438 | 613 | | |

TABLE 4
180 Degree Peel Adhesion
For Dry Film Coating Applications of 18-20 mils
Measured in Newtons/Meter

| | | | 7 Day Testing Time | |
|---|---|---|---|---|
| | 7 Day Testing Time | | Dry/4 Hour | |
| | Dry Condition | | Wet Condition | |
| | Without | With | Without | With |
| Substrate | Detergent | Detergent | Detergent | Detergent |
| coating binder | Treatment | Treatment | Treatment | Treatment |
| PVC Single Ply | | | | |
| Rhoplex EC-1791 | 263 | 298 | 175 | 438 |
| Hypalon ® Single Ply | | | | |
| Rhoplex EC-1791 | 315 | 403 | 158 | 438 |
| Aged Modified Bitumen | | | | |
| MB-3640 | 228 | 350 | | |

Hypalon is a registered trademark of DuPont Dow.

TABLE 5
Adhesion To Chalky Acrylic Coated Aluminum Siding

| | | | Panel #2 | |
|---|---|---|---|---|
| | Panel #1 | | Detergent | |
| | Water Rinse | | then power | |
| Conditions | Only | | wash rinse | |
| Sample | X Hatch | Knife | X Hatch | Knife |
| 24 Hour Dry | | | | |
| Behr ® Premium Exterior Flat | 20% | 2 | 100% | 8 |
| Test Sample Coating | 10% | 2 | 100% | 8 |
| 45 PVC/30VS Flat | | | | |
| 24 Hour Dry 4 Hours Fog | | | | |
| Behr ® Premium Exterior Flat | 20% | 4 | 100% | 8 |
| Test Sample Coating | 0% | 2 | 100% | 6 |
| 45 PVC/30VS Flat | | | | |
| 7 Day Dry | | | | |
| Behr ® Premium Exterior Flat | 0% | 4 | 100% | 8 |
| Test Sample Coating | 0% | 4 | 100% | 8 |
| 45 PVC/30VS Flat | | | | |
| 7 Day Dry, 4 Hours Fog | | | | |
| Behr ® Premium Exterior Flat | 0% | 2 | 100% | 8 |
| Test Sample Coating | 0% | 2 | 100% | 6 |
| 45 PVC/30VS Flat | | | | |

PVC means pigment volume concentration.
VS means volume solids.

X Hatch or Grid Tape Adhesion

Place a comb-like metal template on the surface of the test paint and run the Stanley Utility Knife or Excel Adhesion Knife through each slit, thus inscribing 11 parallel cuts in the paint film. Wear a leather glove on the hand holding the template to avoid cuts. The template is then rotated 90° and placed over the same area, and a second set of 11 cuts is made. The horizontal and vertical cuts form a 100 square test area (the Gardner Adhesion Knife produces similar test areas). One inch wide Permacel™ tape with a 10.16 cm (4 inch) overlap at one end to form a pull tab is applied over the test area. The tape is rubbed with an eraser to assure good contact over the test area, and then using the overlap for grip, the tape is pulled quickly at a 180° angle from the substrate. Then immediately determine knife peel adhesion. These tests should be performed as quickly as possible because adhesion improves with drying exposure in air.

Knife Peel Test

Make two knife cuts through the test film with the Excel Adhesion Knife, formingan X intersecting at about a 30° angle. For difficult or hard to cut substrates, the Stanley Utility Knife can be used. Using the point of the Excel Adhesion Knife, attempt to peel the latex paint from the substrate, at the point of intersection. The degree of peeling difficulty is subjectively rated according to the following chart:

### Knife Peel Rating

10—no peeling

9—very difficult

8—difficult

7—moderately difficult

6—slightly to mod. Difficult

5—slightly difficult

4—fairly easy

3—easy

2—very easy

1—falls off

Each of the samples for Table 6 were tested in accordance with the ASTM D 714 rating scale, rated for both blister size and density.

TABLE 6
Blistering of Chalky Acrylic Coated Aluminum Siding

| | | | Panel #2 | |
|---|---|---|---|---|
| | Panel #1 | | Detergent | |
| | Water Rinse | | then power | |
| Conditions | Only | | wash rinse | |
| Sample | Size | Density | Size | Density |
| 24 Hour Dry 4 Hours Fog | | | | |
| Behr ® Premium Exterior Flat | #8 | Moderate | 10 | 10 |
| Test Sample Coating | #8 | Few | 10 | 10 |
| 45 PVC/30VS Flat | | | | |
| 7 Day Dry, 4 Hours Fog | | | | |
| Behr ® Premium Exterior Flat | #6 | Moderate | 10 | 10 |
| Test Sample Coating | #10 | 10 | 10 | 10 |
| 45 PVC/30VS Flat | | | | |

PVC means pigment volume concentration.
VS means volume solids.

It is shown in Tables 3, 4, 5 and 6 that improvement in adhesion and blister ratings between a coating composition and various substrates are improved through the pre-treatment of the substrate with the aqueous detergent composition of the present invention.

1. A method for improving the adhesion between a coating and a substrate, which method comprises:
(A) selecting a substrate from the group consisting of aluminum, galvinized steel, vinyl, polyvinyl chloride, thermoplastic polyolefin, chlorosulfonated polyethylene, pressure treated wood, plywood and chalky acrylic coated surfaces thereof,
(B) treating a surface of the substrate with an aqueous detergent composition; then
(C) rinsing said surface of the substrate with water to remove said detergent composition; and then
(D) applying a coating composition to said rinsed surface of the substrate,
wherein said aqueous detergent composition has a pH greater than 8 and comprises from 1 to 10% by weight phosphate and from 1 to 10% by weight silicate.

2. The method of claim 1 wherein the phosphate is a monophosphate.

3. The method of claim 2, wherein the monophosphate is trisodium phosphate.

4. The method of claim 1, wherein the silicate is a metasilicate.

5. The method of claim 4, wherein the metasilicate is sodium metasilicate.

6. The method of claim 1, wherein the pH of the detergent composition is in the range of 9 to 14.

7. The method of claim 1, wherein the coating is a mastic or paint coating.

8. The method of claim 1, wherein the rinsing comprises a power wash at a pressure of at least 193×10⁵ N/m² (2500 psi).
